(19) United States
(12) Patent Application Publication
(10) Pub. No.: US 2016/0094597 A1
(43) Pub. Date: Mar. 31, 2016

(54) Storage Medium Storing Communication Program, Communication Terminal, and Communication Method

(71) Applicant: Brother Kogyo Kabushiki Kaisha, Nagoya-shi (JP)

(72) Inventor: Makoto Nishida, Nagoya-shi (JP)

(21) Appl. No.: 14/865,382

(22) Filed: Sep. 25, 2015

(30) Foreign Application Priority Data
Sep. 29, 2014 (JP) 2014-198106

(51) Int. Cl. H04L 29/06

(52) U.S. Cl. CPC H04L 65/4038

(57) ABSTRACT

A program includes: a first acquiring instruction of acquiring, from a storage, first setting information including function identification information, first permission information, and conference identification information that are associated with one another; a second acquiring instruction of acquiring, from the storage, second setting information including the function identification information, second permission information, and organizer identification information that are associated with one another; a comparing instruction of comparing the first permission information with the second permission information for each of the function indicated by the function identification information, based on the first and second setting information; and a notifying instruction of, in a particular case, selectively providing notification relating to at least one different function based on a comparison result. The at least one different function is indicated by the function identification information of which the first and second permission information are different from each other.

### CROSS REFERENCE TO RELATED APPLICATIONS

This application claims priority from Japanese Patent Application No. 2014-198106 filed Sep. 29, 2014. The entire content of the priority application is incorporated herein by reference.

### TECHNICAL FIELD

This disclosure relates to a storage medium storing a communication program, a communication terminal, and a communication method for realizing a Web conference by performing communication through a network.

### BACKGROUND

A system for realizing a Web conference is proposed in which respective users of a plurality of communication terminals connected to a network participate in a virtual conference room to conduct a teleconference. In an electronic conference system, a server computer manages, for each user, various execution authorities such as for browsing of respective conference rooms, maintenance, and browsing of opinions based on operator attribute information, user management information, and conference room management information stored in the server computer. In the Web conference system, the Web conference server creates a user management table based on the information acquired from the Lightweight Directory Access Protocol (LDAP) management table stored in an LDAP server. In the user management table, the users who participate in the Web conference are managed for each group, and each group corresponds to a profile name. The profile name is an attribute name of a corresponding group.

### SUMMARY

According to one aspect, this specification discloses a non-transitory computer-readable storage medium storing a program executable on a computer of a communication terminal. The program includes: a first acquiring instruction of acquiring, from a storage, first setting information including function identification information, first permission information, and conference identification information that are associated with one another, the function identification information being indicative of a function provided in an application for performing a teleconference that is conducted through a virtual conference room on a network between a plurality of communication terminals, the first permission information being indicative of whether the function is available in a particular virtual conference room, the conference identification information identifying the particular virtual conference room; a second acquiring instruction of acquiring, from the storage, second setting information including the function identification information, second permission information, and organizer identification information that are associated with one another, the second permission information being indicative of whether the function is available for an organizer of the particular virtual conference room identified by the conference identification information, the organizer identification information identifying the organizer; a comparing instruction of comparing the first permission information with the second permission information for each of the function indicated by the function identification information, based on the first and second setting information; and a notifying instruction of, in a particular case, selectively providing notification relating to at least one different function based on a comparison result by the comparing instruction, the at least one different function being indicated by the function identification information of which the first permission information and the second permission information are different from each other.

According to another aspect, this specification also discloses a communication terminal. The communication terminal includes a communicator configured to connect to a network, a hardware processor, and a memory storing instructions. When executed by the processor, the instructions cause the processor to perform: acquiring, from a storage, first setting information including function identification information, first permission information, and conference identification information that are associated with one another, the function identification information being indicative of a function provided in an application for performing a teleconference that is conducted through a virtual conference room on the network between a plurality of communication terminals, the first permission information being indicative of whether the function is available in a particular virtual conference room, the conference identification information identifying the particular virtual conference room; acquiring, from the storage, second setting information including the function identification information, second permission information, and organizer identification information that are associated with one another, the second permission information being indicative of whether the function is available for an organizer of the particular virtual conference room identified by the conference identification information, the organizer identification information identifying the organizer; comparing the first permission information with the second permission information for each of the function indicated by the function identification information, based on the first and second setting information, thereby obtaining a comparison result; and selectively providing, in a particular case, notification relating to at least one different function based on the comparison result, the at least one different function being indicated by the function identification information of which the first permission information and the second permission information are different from each other.

According to still another aspect, this specification also discloses a communication method. The communication method includes: acquiring, from a storage, first setting information including function identification information, first permission information, and conference identification information that are associated with one another, the function identification information being indicative of a function provided in an application for performing a teleconference that is conducted through a virtual conference room on a network between a plurality of communication terminals, the first permission information being indicative of whether the function is available in a particular virtual conference room, the conference identification information identifying the particular virtual conference room; acquiring, from the storage, second setting information including the function identification information, second permission information, and organizer identification information that are associated with one another, the second permission information being indicative of whether the function is available for an organizer of the particular virtual conference room identified by the conference identification information, the organizer identification information identifying the organizer; comparing the first permission information with the second permission information for each of the function indicated by the function identification information, based on the first and second setting information, thereby obtaining a comparison result; and selectively providing, in a particular case, notification relating to at least one different function based on the comparison result, the at least one different function being indicated by the function identification information of which the first permission information and the second permission information are different from each other.

### BRIEF DESCRIPTION OF THE DRAWINGS

Embodiments in accordance with this disclosure will be described in detail with reference to the following figures wherein:

FIG. 1 illustrates the outline of a Web conference system 1 and the electrical configuration of a server 11 and a communication terminal 12;

FIG. 2 shows a first permission table 114A and a second permission table 114B;

FIG. 3 shows the flowchart of a main process;

FIG. 4 shows the flowchart of a conference process;

FIG. 5 shows the flowchart of a selection process;

FIG. 6 shows a notification window 20C;

FIG. 7 shows the flowchart of a conference setting display process; and

FIG. 8 shows a notification window 20D.

### DETAILED DESCRIPTION

A function actually available to a user who participates in a conference, out of all the functions available in a conference room, may be managed as the information corresponding to the profile name mentioned above. Or, another person (for example, network administrator) other than the users may set or change an actually-available function. Hereafter, the setting information for actually-available functions is referred to as “function setting information.”

In an example, when the use of a specific function is prohibited in accordance with the change in the function setting information made by another person, a specific operation that was available in a conference room before the change to a user who participates in the conference room may be unavailable, or a specific function may suddenly become unavailable to a user while the user is participating in the conference room. As described above, the change in the function setting information made by another person may cause a problem for a user who participates in the conference room.

An example of an object of one aspect of this disclosure is to provide a communication program, a communication terminal, and a communication method for suppressing inconvenience to a user who participates in a conference room when setting information of a function that is usable in the conference room is changed by another person.

### Outline of Web Conference System 1

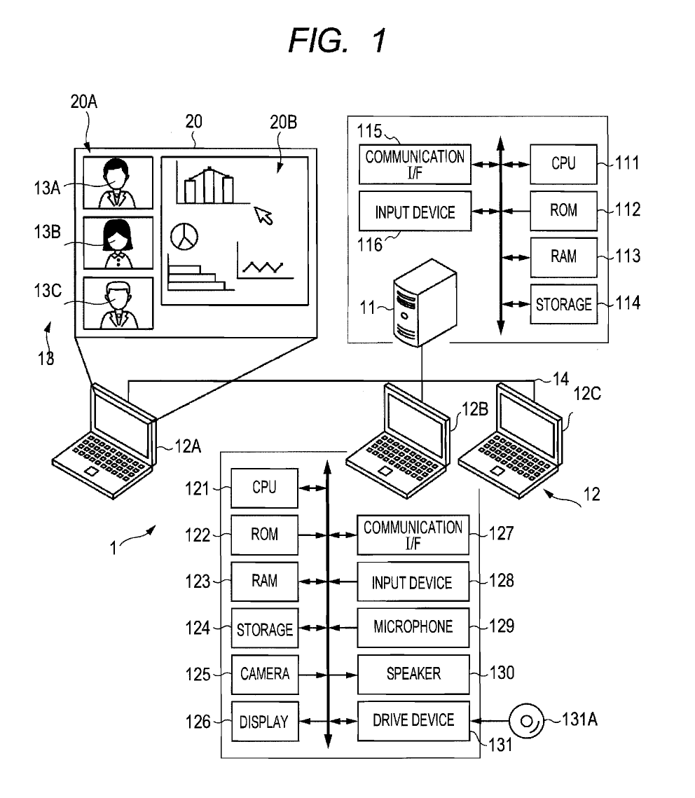

A Web conference system 1 will be described with reference to FIG. 1. The Web conference system 1 includes a server apparatus 11, and communication terminals 12A, 12B and 12C. The communication terminals 12A, 12B and 12C are collectively referred to as a communication terminal 12 or communication terminals 12. The server apparatus 11 and the communication terminals 12 are connected through a network 14. The Web conference system 1 is a system for realizing a Web conference among respective users of the communication terminals 12 by providing a virtual conference room to respective users.

The server apparatus 11 is a well-known Multi-point Control Unit (MCU). The program of the application for conducting the Web conference (hereinafter, referred to as “conference application”) is installed in a well-known general-purpose Personal Computer (PC) so as to configure the communication terminal 12. Hereinafter, respective users of the communication terminals 12A, 12B and 12C are correspondingly referred to as users 13A, 13B and 13C. The users 13A, 13B and 13C are collectively referred to as users 13. The server apparatus 11 may be a general-purpose server in hardware. The program of the conference application may be installed to a dedicated terminal for a teleconference so as to configure at least one of the communication terminals 12.

<Electrical Configuration>

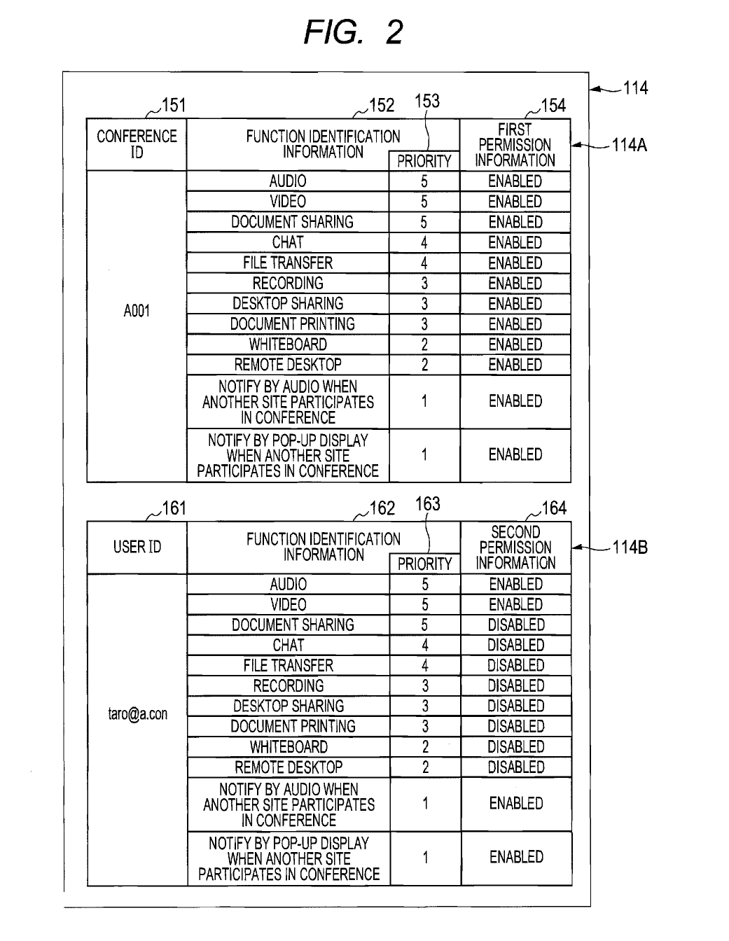

The electrical configuration of the server apparatus 11 will be described. The server apparatus 11 includes a CPU 111 that controls the server apparatus 11. The CPU 111 is electrically connected to a ROM 112, a RAM 113, a storage 114, a communication interface (I/F) 115, and an input device 116. The ROM 112 stores a boot program, a Basic Input/Output System (BIOS), and so on. The RAM 113 stores a timer, a counter and temporary data. The storage 114 stores the program that makes the CPU 111 execute processing, and an operating system (OS). The storage 114 also stores first setting information 114A and second setting information 114B (see FIG. 2), which are described later. The communication I/F 115 is an interface element through which the server apparatus 11 connects to the network 14. The CPU 111 transmits/receives data to/from other devices connected to the network 14 through the communication I/F 115. The input device 116 includes, for example, a button, a keyboard, and a mouse.

The electrical configuration of the communication terminal 12 will be described. The communication terminal 12 includes a CPU 121 that controls the communication terminal 12. The CPU 121 is electrically connected to a ROM 122, a RAM 123, a storage 124, a camera 125, a display 126, a communication I/F 127, an input device 128, a microphone 129, a speaker 130, and a drive device 131. The ROM 122 stores a boot program, a BIOS, and so on. The RAM 123 stores a timer, a counter, flag information, temporary data, and so on. The storage 124 includes a non-transitory computer-readable storage medium, for example, a hard disk. The storage 124 stores the program of the conference application and an OS. The storage 124 may include, for example, a flash memory and/or a ROM. Any storage medium may be used as the non-transitory storage medium as long as the medium can store information regardless of a time period in which information is stored. The non-transitory storage medium may not include signals to be temporarily transmitted.

The display 126 is a Liquid Crystal Display (LCD). The communication I/F 127 is an interface element (for example, LAN card) through which the communication terminal 12 connects to the network 14, or another interface element (for example, Wi-Fi communication modem) through which the communication terminal 12 connects for wireless communication to an access point (not shown in the figure) that is connected to the network 14. The CPU 121 transmits/receives data to/from other devices connected to the network 14 through the communication I/F 127. The input device 128 includes, for example, a button, a keyboard, a mouse, a touch panel, and so on. The drive device 131 is capable of reading out information stored in a computer-readable storage medium 131A, for example, a semiconductor memory. The CPU 121 can read out the program stored in the storage medium 131A by the drive device 131, and store the read-out program in the storage 124.

The CPU 121 is an example of a hardware processor. The hardware processor may be any processor excluding software. A general-purpose processor may be used as the hardware processor. A part of the process executed by the CPU 121 may be executed by another hardware processor (for example, ASIC). The process executed by the CPU 121 may be distributedly executed by a plurality of electronic devices (that is, a plurality of CPUs). The process may be executed by a combination of a CPU and an ASIC. The program may be downloaded (that is, being transmitted as a transmission signal), for example, from another server connected to the network 14, and stored in the storage 124. In this case, the program is stored in a non-transitory storage medium, such as an HDD provided in another server.

<Outline of Conference Room>

A procedure in a case where a user of the communication terminal 12 uses the virtual conference room (hereinafter, simply referred to as “conference room”) provided by the server apparatus 11 will be described by use of an example. First, the user 13A of the communication terminal 12A enters the user ID and the password of the user 13A to log in to the Web conference system 1. Next, the user 13A transmits email respectively to the electronic mail addresses of the communication terminals 12B and 12C used by the users 13B and 13C, respectively, in order to invite the users 13B and 13C to the conference room organized by the user 13A. The email includes the URL (Uniform Resource Locator) that each of the users 13B and 13C needs to participate in the conference room. The URL includes a conference ID that identifies a conference room.

Next, the user 13A starts the conference application by operating the communication terminal 12A. The user 13A performs an input operation to enter the conference room organized by the user 13A. Upon detecting the input operation, the CPU 121 of the communication terminal 12A transmits to the server apparatus 11 the conference ID of the conference room organized by the user 13A. The communication terminal 12A executes a conference connection process by communicating with the server apparatus 11. In response to the executed conference connection process, the CPU 111 of the server apparatus 11 establishes, with the communication terminal 12A, a session for the conference room identified by the conference ID.

The CPU 121 of the communication terminal 12B receives the email transmitted from the communication terminal 12A, and displays a URL in the display 126. The user 13B performs an input operation to select the URL. Upon detecting the input operation, the CPU 121 of the communication terminal 12B starts the conference application. The CPU 121 of the communication terminal 12B transmits the conference ID included in the URL to the server apparatus 11. The communication terminal 12B executes the conference connection process by communicating with the server apparatus 11. In response to the executed conference connection process, the CPU 111 of the server apparatus 11 establishes, with the communication terminal 12B, a session for the conference room identified by the conference ID. The same operation is also performed with the communication terminal 12C.

By the above-described operation, the server apparatus 11 and the communication terminals 12 are connected for conference. Here, the users 13A, 13B and 13C participate in the conference room organized by the user 13A. Due to the execution of the conference application by the CPU 121 of the communication terminal 12, a conference application window 20 shown in FIG. 1 is displayed in the display 126. The conference application window 20 includes a video window 20A in which video shot by the camera 125 of the communication terminal 12 is displayed. Further, due to the execution of the conference application by the CPU 121 of the communication terminal 12, audio collected by the microphone 129 of another communication terminal 12 is outputted from the speaker 130. The user 13 can have a teleconference with another user 13 while checking the video and the audio of another user 13 participating in the conference room organized by the user 13A. Hereinafter, the user 13 who starts the conference by inviting another user 13 to the conference room may be referred to as “organizer,” while the user who participates in the conference room organized by the organizer may be referred to as “participant.” The user 13A may also be referred to as “organizer 13A,” while the users 13B and 13C may also be referred to as “participants 13B and 13C.”

The conference application described above provides a plurality of functions in the conference room to the user 13. The plurality of functions include, for example, “audio,” “video,” “document sharing,” “chat,” “file transfer,” “recording,” “desktop sharing,” “document printing,” “whiteboard,” “remote desktop,” “notify by audio when another site participates in conference,” and “notify by pop-up display when another site participates in conference.” Each of the plurality of functions is specifically described below.

The function of “audio” is for outputting the sound collected by the microphone 129 of other communication terminals 12 from the speaker 130. The function of “video” is for displaying the video shot by the camera 125 of the communication terminals 12 in the video window 20A of the conference application window 20. The function of “document sharing” is for displaying a document for sharing with other communication terminals 12 in a document window 20B of the conference application window 20. The function of “chat” is for chatting. The function of “file transfer” is for transferring a file to other communication terminals 12. The function of “recording” is for recording video, audio and shared document in the conference. The function of “desktop sharing” is for sharing a desktop with other communication terminals 12. The function of “document printing” is for printing a document shared by the function of “document sharing.” The function of “whiteboard” is for sharing a virtual whiteboard with other communication terminals 12. The function of “remote desktop” is for remotely operating a desktop of another communication terminal 12. The function of “notify by audio when another site participates in conference” is for providing notification to another user 13 in the conference room by audio, when the user 13 of the communication terminal 12 participates in the conference room in a middle of a conference. The function of “notify by pop-up display when another site participates in conference” is for providing notification to another user 13 in the conference room by video, when the user 13 of the communication terminal 12 participates in the conference room in a middle of a conference.

The server apparatus 11 manages a setting for each conference room for whether each of the plurality of functions described above is enabled or disabled based on the first setting information 114A (see FIG. 2) stored in the storage 114. The first setting information 114A will be described with reference to FIG. 2. The first setting information 114A is a table including a conference ID 151, function identification information 152, and first permission information 154 that correspond to one another. The function identification information 152 identifies every function provided to the organizer and the participants in the conference room identified by the corresponding conference ID 151. The first permission information 154 shows which functions are actually available to the organizer and the participants among all the functions provided in the conference room identified by the corresponding conference ID 151.

The function identification information 152 of the first setting information 114A corresponds to priority information 153. The priority information 153 shows the priority of the function identified by the corresponding function identification information 152. In the priority information 153, the larger the value of the corresponding priority is, the higher the priority is. In the first setting information 114A, each of “audio,” “video” and “document sharing” corresponds to the priority information 153 showing priority “5.” Each of “chat” and “file transfer” corresponds to the priority information 153 showing priority “4.” Each of “recording,” “desktop sharing” and “document printing” corresponds to the priority information 153 showing priority “3.” Each of “whiteboard” and “remote desktop” corresponds to the priority information 153 showing priority “2.” Each of “notify by audio when another site participates in conference” and “notify by pop-up display when another site participates in conference” corresponds to the priority information 153 showing priority “1.” Thus, the priority of “audio,” “video” and “document sharing” is the highest in comparison with the priorities of other plurality of functions.

The organizer 13A can update each setting of the plurality of functions described above. For example, the organizer 13A logs in to the Web conference system 1 by use of a Web browser, and then makes the Web browser display a setting window (not shown in a figure) for a specific conference room. The setting window shows selectable check boxes that either enable or disable, each of which corresponds to each of the plurality of functions. The organizer 13A performs an input operation to select enabling or disabling for each of the plurality of functions. The CPU 121 of the communication terminal 12A generates a command including a conference ID and enabled/disabled information. The conference ID included in the command identifies the conference room displayed in the setting window. The enabled/disabled information included in the command indicates whether each of the plurality of functions is enabled or disabled. The CPU 121 transmits the generated command to the server apparatus 11.

The CPU 111 of the server apparatus 11 receives the transmitted command, and acquires the conference ID and the enabled/disabled information. The CPU 111 updates the first permission information 154 in the first setting information 114A corresponding to the acquired conference ID for each of the plurality of functions based on the acquired enabled/disabled information. Specifically, when the acquired enabled/disabled information shows that a specific function is enabled, the first permission information 154 showing being available (“enabled” in FIG. 2) is associated with the function identification information 152 showing the specific function. On the other hand, when the acquired enabled/disabled information shows that a specific function is disabled, the first permission information 154 showing being unavailable (“disabled” in FIG. 2) is associated with the function identification information 152 showing the specific function.

Further, a predetermined specific person is allowed to limit, for each organizer, each setting of the plurality of functions made by an organizer. The specific person is, for example, a system administrator of the Web conference system 1. In the description below, it is assumed that the specific person is a system administrator. As an example case where the system administrator limits each setting of the plurality of functions made by an organizer, the system administrator may limit the plurality of available functions, for example, based on organizer's position in the group to which the organizer belongs.

For example, the system administrator inputs the user ID of a specific organizer through the input device 116 of the server apparatus 11. The system administrator also performs an input operation to give instruction on whether each of the plurality of functions is enabled or disabled. The CPU 111 of the server apparatus 11 acquires the input user ID and enabled/disabled information. The enabled/disabled information shows either enabling or disabling for each of the plurality of functions. The system administrator may input a group including the user ID of the specific organizer instead of the user ID of the specific organizer. This allows for a comprehensive change (change at once) in setting for the enabled/disabled information with regard to the plurality of user IDs associated with the group.

The CPU 111 of the server apparatus 11 manages whether to limit the setting made by the organizer, based on the second setting information 114B (see FIG. 2) stored in the storage 114. The second setting information 114B will be described with reference to FIG. 2. The second setting information 114B is a table including a user ID 161, function identification information 162, and second permission information 164 that correspond to one another. The user ID 161 identifies an organizer. The function identification information 162 identifies every function provided to the organizer and the participants in the conference room organized by the organizer identified by the corresponding user ID 161. The function identification information 162 corresponds to priority information 163 in the same manner as the first setting information 114A. The second permission information 164 shows whether each function is enabled or disabled with respect to the organizer identified by the corresponding user ID 161. That is, the function set as being “enabled” to the organizer in the second setting information 114B can be set, by the organizer, to either “enabled” or “disabled” in the conference room organized by the organizer. Meanwhile, the function set as being “disabled” to the organizer in the second setting information 114B remains “disabled” (unavailable) in the conference room organized by the organizer, regardless of the organizer's intention.

That is, the second permission information 164 in the second setting information 114B takes precedence over the first permission information 154 in the first setting information 114A. The CPU 111 of the server apparatus 11 updates the second permission information 164 in the second setting information 114B corresponding to the acquired user ID 161 for each of the plurality of functions, based on the enabled/disabled information.

Hereinafter, “A001” of the conference ID 151 in the first setting information 114A shown in FIG. 2 is the identification information showing the conference room organized by the organizer 13A. In addition, “taro@a.com” of the user ID 161 in the second setting information 114B is the identification information for identifying the organizer 13A. In comparison between the first permission information 154 in the first setting information 114A and the second permission information 164 in the second setting information 114B for each of the same functions, the first permission information 154 and the second permission information 164 corresponding to the functions of “document sharing,” “chat,” “file transfer,” “recording,” “desktop sharing,” “document printing,” “whiteboard,” and “remote desktop” are different. The difference occurs, for example, when after the organizer 13A organizes a conference room where a specific function is set as being enabled, the system administrator sets the specific function as being disabled to the organizer 13A. Since the second permission information 164 takes precedence over the first permission information 154, in this case, the CPU 111 of the server apparatus 11 determines whether to enable the corresponding function based on the second permission information 164 in the second setting information 114B. Therefore, in the conference room organized by the organizer 13A, the functions of “document sharing,” “chat,” “file transfer,” “recording,” “desktop sharing,” “document printing,” “whiteboard,” and “remote desktop” become disabled. Thus, in the conference room organized by the organizer 13A, the organizer and the participants cannot use the functions of “document sharing,” “chat,” “file transfer,” “recording,” “desktop sharing,” “document printing,” “whiteboard,” and “remote desktop”, which is different from the setting for the conference room made by the organizer 13A in advance.

<Details of Process by CPU 121 of Communication Terminal 12>

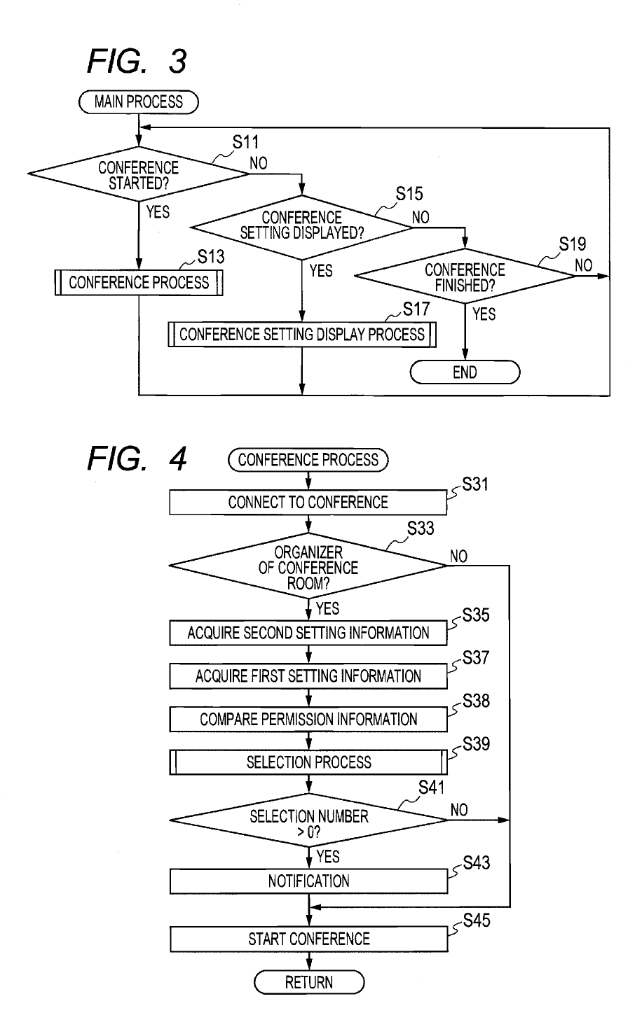

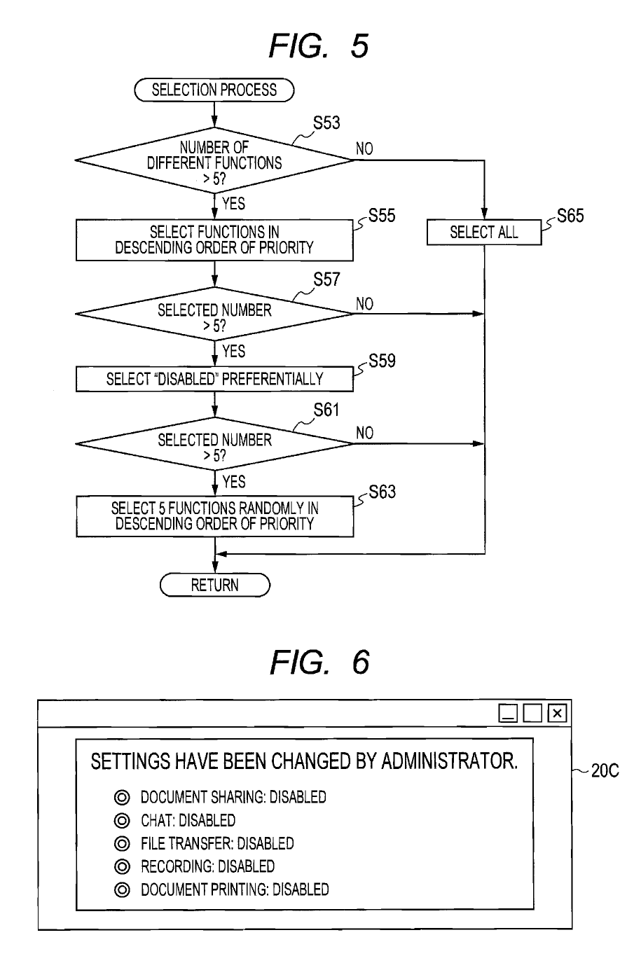

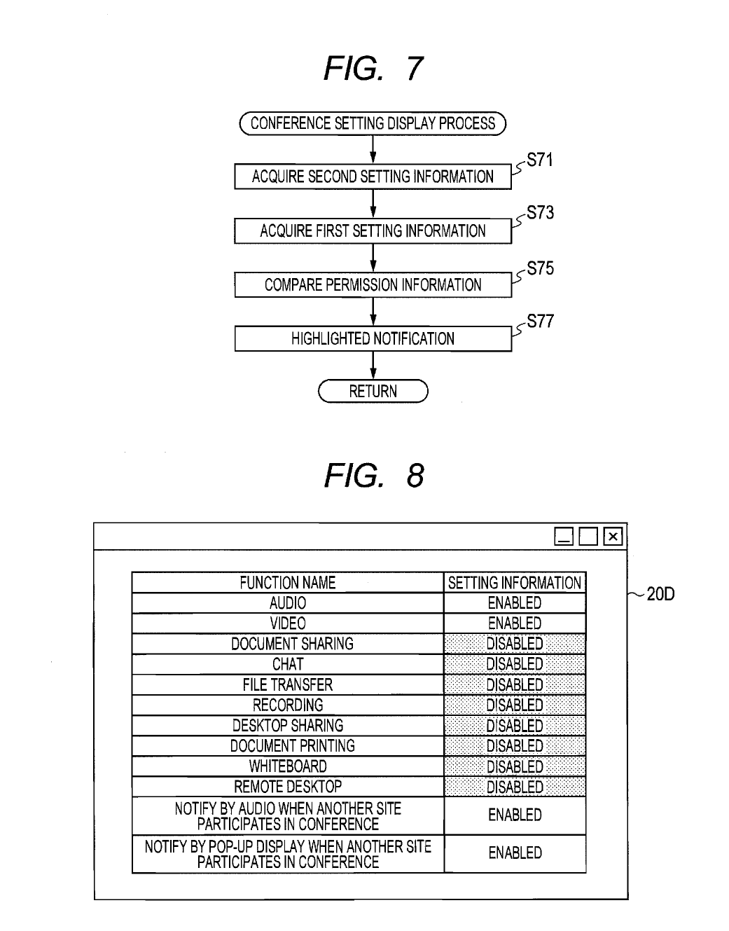

A main process executed by the CPU 121 of the communication terminal 12 will be described with reference to FIG. 3, FIG. 4, FIG. 5 and FIG. 7. When the conference application is started, the CPU 121 starts the main process by executing the program stored in the storage 124. Note that the cases where the conference application is started include (1) a case where the conference application is started before the organizer 13A performs an input operation to enter the conference room, and (2) a case where the conference application is started when the participants 13B and 13C perform an input operation to select the URL.

As shown in FIG. 3, the CPU 121 determines whether to start the conference (S11). When the user 13 of the communication terminal 12 is the organizer 13A, the CPU 121 determines to start the conference in response to detecting the input operation for entering the conference room (S11: YES). When the user 13 of the communication terminal 12 is the participant 13B or the participant 13C, since the URL necessary for the participation in the conference room has already been selected, the CPU 121 determines to start the conference immediately after the main process starts (S11: YES). The CPU 121 executes a conference process (see FIG. 4) (S13). The CPU 121 returns the process to S11 after the conference process ends.

The conference process will be described with reference to FIG. 4. The CPU 121 executes the conference connection process by communicating with the server apparatus 11 (S31). This establishes a session for the conference room between the communication terminal 12 and the server apparatus 11. The CPU 121 determines whether the user 13 is the organizer 13A (S33). When the input operation to enter the conference room is performed, the CPU 121 determines that the user 13 is the organizer 13A (S33: YES).

The CPU 121 may perform the determination of S33 by receiving the information showing the role (for example, organizer or participant) of the user of the communication terminal 12 from the server apparatus 11. For example, the server apparatus 11 determines the role of the user of the communication terminal 12 by receiving specific information (for example, organizer's password) from the communication terminal 12 in the process of S11. The CPU 121 receives the information showing the role of the user determined by the server apparatus 11, from the server apparatus 11 in the process of S33. The CPU 121 determines whether the user 13 is the organizer 13A based on the received information (S33).

When determining that the user 13 is the organizer 13A (S33: YES), the CPU 121 acquires the second setting information 114B from the server apparatus 11 by communicating with the server apparatus 11 (S35). Next, the CPU 121 acquires the first setting information 114A from the server apparatus 11 by communicating with the server apparatus 11 (S37). Then, the CPU 121 compares the first permission information 154 in the first setting information 114A with the second permission information 164 in the second setting information 114B for each function (S38). When the first permission information 154 and the second permission information 164 are different, the CPU 121 stores at least one of the corresponding functions as at least one different function in the RAM 123. The CPU 121 executes a selection process (see FIG. 5) (S39).

The selection process will be described with reference to FIG. 5. The CPU 121 determines whether the number of at least one different function stored in the RAM 123 is more than 5 (S53). When determining that the number of at least one different function is 5 or less (S53: NO), the CPU 121 selects all of at least one different function stored in the RAM 123 as the different function notified to the organizer 13A (S65). The CPU 121 ends the selection process and returns the process to the conference process (see FIG. 4). When determining that the number of at least one different function stored in the RAM 123 is more than “5” (S53: YES), the CPU 121 advances the process to S55.

The CPU 121 selects one or more function from the plurality of different functions stored in the RAM 123 based on the priorities shown in the priority information 153, 163 corresponding to the function identification information 152, 162, respectively (S55). For example, in the description below, variables of “residual number L,” “total number M” and “priority N” are defined. The initial value of “residual number L” is the number of the plurality of different functions stored in the RAM 123 in the comparison step of S38. Since the CPU 121 determines in the process of S53 that the number of at least one different function stored in the RAM 123 is more than 5, naturally the initial value of “residual number L” is more than “5.” “Total number M” shows the total number of the plurality of different functions selected out of the plurality of different functions stored in the RAM 123. The initial value of “total number M” is “0.” “Priority N” shows priority. The initial value of “priority N” is “5.”

First, the CPU 121 selects all the different functions corresponding to the priority information 153 and the priority information 163 showing “priority N” out of “residual number L” of the different functions stored in the RAM 123. The CPU 121 updates “total number M” by adding the number of all the selected different functions to “total number M.” The CPU 121 updates “residual number L” by subtracting the number of all the selected different functions from “residual number L.” The CPU 121 compares “total number M” with “5.” When “total number M” is less than “5,” the CPU 121 updates “priority N” by subtracting 1 from “priority N.” Then, the CPU 121 further selects all the different functions corresponding to the priority information 153 and the priority information 163 showing the updated “priority N.” The CPU 121 updates “total number M” by adding the number of at least one selected different function to “total number M.” The CPU 121 updates “residual number L” by subtracting the number of all the selected different functions from “residual number L.” The CPU 121 compares “total number M” with “5.” When “total number M” is less than “5,” the CPU 121 updates “priority N” by subtracting 1 from “priority N.”

The CPU 121 repeats the steps above until “total number M” becomes “5” or more, or “residual number L” becomes “0.”

The process is specifically described with reference to the first setting information 114A and the second setting information 114B in FIG. 2. In the first setting information 114A and the second setting information 114B, the first permission information 154 and the second permission information 164 corresponding to the functions of “document sharing,” “chat,” “file transfer,” “recording,” “desktop sharing,” “document printing,” “whiteboard,” and “remote desktop” are different. Thus, eight different functions are stored in the RAM 123 after the comparison in the process of S38 (FIG. 4). The initial values of “residual number L,” “total number M” and “priority N” are respectively “8,” “0” and “5.”

The CPU 121 selects “document sharing” that is the different function corresponding to the priority information 153 and the priority information 163 showing priority “5” (“priority N”) out of “8” (“residual number L”) different functions stored in the RAM 123. The CPU 121 updates “total number M” to be “1” that is the value acquired by adding a number “1” of the number of the selected different function, “document sharing,” to “total number M” (“0”) before updating. The CPU 121 updates “residual number L” to be “7” that is the value acquired by subtracting “1” of the number of the selected different function, “document sharing,” from “residual number L” (“8”) before updating. The CPU 121 compares “total number M” (“1”) with “5.” Since “total number M” (“1”) is less than “5,” the CPU 121 updates “priority N” to be “4” that is the value acquired by subtracting 1 from “priority N” (“5”) before updating.

The CPU 121 further selects “chat” and “file transfer” that are the different functions corresponding to the priority information 153 and the priority information 163 showing priority “4” (“priority N”) after updating. The CPU 121 updates “total number M” to be “3” that is the value acquired by adding “2” of the number of the selected different functions, “chat” and “file transfer,” to “total number M” (“1”) before updating. The CPU 121 updates “residual number L” to be “5” that is the value acquired by subtracting “2” of the number of the selected different functions, “chat” and “file transfer,” from “residual number L” (“7”) before updating. Since “total number M” (“3”) is less than “5,” the CPU 121 updates “priority N” to be “3” that is the value acquired by subtracting 1 from “priority N” (“4”) before updating.

The CPU 121 further selects “recording,” “desktop sharing” and “document printing” that are the different functions corresponding to the priority information 153 and the priority information 163 showing priority “3” (“priority N”) after updating. The CPU 121 updates “total number M” to be “6” that is the value acquired by adding “3” of the number of the selected different functions, “recording,” “desktop sharing” and “document printing,” to “total number M” (“3”) before updating. The CPU 121 updates “residual number L” to be “2” that is the value acquired by subtracting “3” of the number of the selected different functions, “recording,” “desktop sharing” and “document printing,” from “residual number L” (“5”) before updating. Since “total number M” (“6”) is more than “5,” the CPU 121 ends the process of S55. Eventually, the plurality of different functions of “document sharing,” “chat,” “file transfer,” “recording,” “desktop sharing,” and “document printing” are selected.

As shown in FIG. 5, the CPU 121 determines whether the number of the plurality of different functions selected in the process of S55 (“total number M”) is more than “5” (S57). The determination by the CPU 121 that the number of the plurality of different functions selected in the process of S55 is not more than “5” (S57: NO) means that the number of the plurality of different functions selected in the process of S55 is “5.” In this case, the CPU 121 ends the selection process and returns the process to the main process (FIG. 2). Meanwhile, when determining that the number of the plurality of different functions selected in the process of S55 is more than “5” (S57: YES), the CPU 121 advances the process to S59.

The CPU 121 further selects at least one different function associated with the second permission information 164 showing “disabled” in the second setting information 114B, out of the plurality of different functions selected in the process of S55 (S59). The CPU 121 determines whether the number of the plurality of different functions selected in the process of S59 is more than “5” (S61). When determining that the number of the plurality of different functions selected in the process of S59 is not more than “5” (S61: NO), the CPU 121 selects “5” or less of different functions associated with the second permission information 164 showing “disabled” as the different functions notified to the organizer 13A. The CPU 121 ends the selection process and returns the process to the main process (FIG. 2). Meanwhile, when determining that the number of the plurality of different functions selected in the process of S59 is more than “5” (YES in S61), the CPU 121 advances the process to S63.

The process is described by use of a specific example with reference to FIG. 2. The description below is based on an example case where six different functions, “document sharing,” “chat,” “file transfer,” “recording,” “desktop sharing” and “document printing,” are selected in the process of S55. All of the six selected different functions correspond to the second permission information 164 showing “disabled” in the second setting information 114B. In this case, all of the six different functions are selected in the process of S59. The CPU 121 determines that “6” of the number of the plurality of different functions selected in the process of S59 is more than “5,” and advances the process to S63.

As shown in FIG. 5, the CPU 121 randomly selects five different functions in descending order of priority (that is, high priority comes first) out of more than “5” different functions selected in the process of S59 (S63). More specifically, the CPU 121 adds the number of the different functions corresponding to each priority in descending order of priority. When the number of the different functions exceeds “5”, the CPU 121 randomly selects an appropriate number of the different functions out of the different functions corresponding to the priority at that time, thereby selecting five different functions. The CPU 121 ends the selection process and returns the process to the conference process (see FIG. 4).

The step will be described by use of a specific example with reference to FIG. 2. The description below is based on an example case where six different functions, “document sharing,” “chat,” “file transfer,” “recording,” “desktop sharing” and “document printing” are selected in the process of S59. In this case, first the CPU 121 selects “document sharing” that is the different function corresponding to the priority information 153, 163 showing priority “5” out of the different functions “document sharing,” “chat,” “file transfer,” “recording,” “desktop sharing” and “document printing.” At this point, the number of the plurality of selected different functions is “1,” which is less than “5.” Next, the CPU 121 selects “chat” and “file transfer” that are the plurality of different functions corresponding to the priority information 153, 163 showing priority “4” out of the plurality of remaining different functions “chat,” “file transfer,” “recording,” “desktop sharing” and “document printing.” At this point, the number of the plurality of selected different functions is “3,” which is less than “5.” Next, the CPU 121 selects “recording,” “desktop sharing” and “document printing” that are the plurality of different functions corresponding to the priority information 153, 163 showing priority “3” out of the plurality of remaining different functions “recording,” “desktop sharing” and “document printing.” At this point, the number of the plurality of selected different functions is “6,” which is more than “5.”

In this case, the CPU 121 randomly selects two different functions out of the plurality of last-selected different functions “recording,” “desktop sharing” and “document printing” so as to make the number of the plurality of eventually-selected different functions be “5.” The specific method for random selection is not limited to a specified method; for example, a random number may be calculated by a known method, and a particular number of different functions may be randomly selected out of the plurality of different functions based on the calculated random number.

As shown in FIG. 4, after the selection process (S39) ends, the CPU 121 determines whether the number of the different functions selected in the selection process is more than “0” (S41). When determining that the number of the different functions selected in the selection process is “0” (S41: NO), the CPU 121 advances the process to S45. When determining that the number of the different functions selected in the selection process is more than “0” (S41: YES), the CPU 121 displays in the display 126 a notification window 20C (see FIG. 6, described later) showing the selected different functions and whether each of the selected different functions is enabled or disabled (S43). The CPU 121 advances the process to S45. The CPU 121 starts the conference by executing at least one of the enabled functions based on the second setting information 114B (S45). The CPU 121 ends the conference process and returns the process to the main process (see FIG. 3).

As shown in FIG. 6, the notification window 20C shows the text of “Setting has been changed by administrator,” notifying that the conference is started based on the setting of the functions different from the setting made by the organizer. The notification window 20C also shows the plurality of different functions eventually selected in the selection process (see FIG. 5), “document sharing,” “chat,” “file transfer,” “recording” and “document printing,” and the fact that each of the functions is disabled.

As shown in FIG. 3, when determining not to start the conference (S11: NO), the CPU 121 determines whether an instruction to display each setting of the plurality of functions provided in the conference room has been detected through the input device 128 (S15). When determining that the instruction to display each setting of the plurality of functions has been detected (S15: YES), the CPU 121 executes a conference setting display process (see FIG. 7) (S17). The CPU 121 returns the process to S11 after the conference setting display process ends.

The conference setting display process will be described with reference to FIG. 7. The CPU 121 acquires the second setting information 114B (see FIG. 2) from the server apparatus 11 by communicating with the server apparatus 11 (S71). Next, the CPU 121 acquires the first setting information 114A (see FIG. 2) from the server apparatus 11, by communicating with the server apparatus 11 (S73). The CPU 121 compares the first permission information 154 in the first setting information 114A with the second permission information 164 in the second setting information 114B for each function (S75). The CPU 121 displays a notification window 20D (see FIG. 8, described later) in the display 126 based on the comparison result (S77). The CPU 121 ends the conference setting display process and returns the process to the main process (see FIG. 3).

As shown in FIG. 8, the notification window 20D shows, as function names, all the plurality of functions provided in the conference room (“audio,” “video,” “document sharing,” “chat,” “file transfer,” “recording,” “desktop sharing,” “document printing,” “whiteboard,” “remote desktop,” “notify by audio when another site participates in conference” and “notify by pop-up display when another site participates in conference”). The notification window 20D also shows, as setting information corresponding to respective function names, “enabled” when each of the plurality of functions is enabled, or “disabled” when each of the plurality of functions is disabled. Moreover, in the notification window 20D, with regard to the setting information corresponding to the function names of the functions different between the first permission information 154 and the second permission information 164 (see FIG. 2) among the setting information corresponding to the plurality of functions, “enabled” or “disabled” shown in the prioritized second permission information 164 is highlighted.

As shown in FIG. 3, when determining that the instruction to display each setting of the plurality of functions provided in the conference room has not been detected (S15: NO), the CPU 121 determines whether the instruction to terminate the conference has been detected through the input device 128 (S19). When determining that the instruction to terminate the conference has not been detected (S19: NO), the CPU 121 returns the process to S11. When determining that the instruction to terminate the conference has been detected (S19: YES), the CPU 121 ends the main process.

### MAJOR EFFECTS OF EMBODIMENTS

As described so far, the CPU 121 of the communication terminal 12 acquires the first setting information 114A and the second setting information 114B from the server apparatus 11 (S35 and S37). The CPU 121 compares the first permission information 154 with the second permission information 164 for each function (S38). When the first permission information 154 and the second permission information 164 are different, the CPU 121 displays in the display 126 the notification window 20C showing at least one corresponding different function (S43). This allows the CPU 121 to selectively notify the user 13 of at least one different function. Accordingly, the user 13 can recognize through the display 126 specific functions changed to become unavailable or available in the conference room by a change in the second setting information 114B made by the system administrator.

When the number of the plurality of different functions is more than “5” (S53: YES), the CPU 121 selects “5” or less of the plurality of different functions (S55, S59 and S63), and displays the selected functions in the display 126 (S43). In this case, the CPU 121 can suppress the number of the plurality of different functions notified to the user 13 to be “5” or less. Therefore, the CPU 121 can avoid giving to the user 13 notification that displays many different functions at one time in the display 126. Thus, the CPU 121 can notify the user 13 of the plurality of different functions in an easily recognizable state for the user 13.

When the number of the plurality of different functions is more than “5” (S53: YES), the CPU 121 selects five functions in descending order of priority based on the priorities shown by the priority information 153, 163 corresponding to the plurality of functions (S55), and displays the selected functions in the display 126 (S43). In this case, the CPU 121 can preferentially notify the user 13 of the different functions having the highest priority, which allows for appropriately giving notification regarding the different functions useful to the user 13.

In the first setting information 114A, each of “audio,” “video” and “document sharing” corresponds to the priority information 153 showing highest priority “5,” while each of the other plurality of functions corresponds to the priority information 153 showing one of priorities “4” to “1,” less than priority “5.” The function of “audio” relates to audio; the function of “video” relates to video; and the function of “document sharing” relates to document sharing. Thus, the CPU 121 can notify the user 13 of the different functions relating to audio, video and document sharing more preferentially than other functions. In many cases, these functions are used with high frequency when the user 13 conducts a teleconference. Therefore, a communication terminal can preferentially notify the user 13 about the functions used with high frequency in the Web conference.

When a function provided in the conference room is changed from an available state to an unavailable state, a problem often arises in the progress of the conference. As for this point, when the number of the plurality of different functions selected based on the priority information 153, 163 is more than “5” (S57: YES), the CPU 121 selects the plurality of different functions corresponding to “disabled” in the setting information (S59). This notifies the user 13 of the functions changed to be unavailable by a change in the second setting information 114B made by the system administrator, which allows the CPU 121 to appropriately prevent a problem from arising when a conference is in progress.

When detecting the instruction to start the conference (S11: YES), the CPU 121 executes the conference connection process (S31). After establishing a session with the server apparatus 11, the CPU 121 can notify the user 13 who participates in the conference that has started in response to the establishment of the session, about at least one different function (S43). Since the at least one different function is equivalent to the functions changed to be unavailable or available in the conference room, the notification is especially effective for the user 13 who participates in the conference room. Therefore, since the CPU 121 can notify the user 13 who participates in the conference room about at least one different function, the CPU 121 can give effective notification of at least one different function.

When the instruction to display the plurality of respective functions provided in the conference room has been detected through the input device 128 (S15: YES), the CPU 121 displays the notification window 20D in the display 126 (S77). In the notification window 20D, the setting information corresponding to the different function among the setting information corresponding to the plurality of functions is highlighted with outline characters. In this way, the CPU 121 notifies the user 13 about at least one different function in a manner different from other functions so as to be distinguishable, which allows the user 13 to recognize the at least one different function in a manner distinguished from other functions. Note that the CPU 121 may notify the user 13 about at least one different function in another manner different from other functions. For example, the setting information corresponding to the different function may be displayed in different color, brightness, font, and/or pattern.

The first setting information 114A is set by the organizer. In the conference room organized by the organizer, the functions available to the organizer and the participants are specified based on the second setting information 114B when the first permission information 154 and the second permission information 164 are different. In this case, since the conference may be held based on the setting different from the setting made by the organizer, the notification regarding the different function is especially effective for the organizer. Meanwhile, the CPU 121 notifies only the organizer of the conference room about at least one different function by use of the notification window 20C (S33: YES). This allows for more effective notification by the CPU 121 regarding at least one different function.

### Modifications

While the disclosure has been described in detail with reference to the above aspects thereof, it would be apparent to those skilled in the art that various changes and modifications may be made therein without departing from the scope of the claims. In the following description, like parts and components are designated by the same reference numerals to avoid duplicating description.

In the above-described embodiment, the first setting information 114A and the second setting information 114B are stored in the storage 114 of the server apparatus 11. The CPU 121 of the communication terminal 12 acquires the first setting information 114A and the second setting information 114B by communicating with the server apparatus 11. However, the first setting information 114A and the second setting information 114B may be stored in another device different from the server apparatus 11. The first setting information 114A and the second setting information 114B may be stored, for example, in the storage 124 of the communication terminal 12.

The above-described main process is executed by the CPU 121 of the communication terminal 12. However, at least part of the main process may be executed by the CPU 111 of the server apparatus 11. In an example, the CPU 111 of the server apparatus 11 may identify at least one different function information by comparing the first permission information 154 in the first setting information 114A with the second permission information 164 in the second setting information 114B, and may transmit a command to display the notification window 20C or the notification window 20D to the communication terminal 12. In response to the reception of the transmitted command, the CPU 121 of the communication terminal 12 may display the notification window 20C or the notification window 20D in accordance with the instruction in the display 126.

The maximum number of the plurality of different functions to be displayed in the notification window 20C is arbitrary and not limited to “5.” The number may be “4” or less, or “6” or more.

Each of the plurality of functions shown in the function identification information 152 of the first setting information 114A and the function identification information 162 of the second setting information 114B corresponds to the priority information 153, 163 showing priority. The CPU 121 may allow the user 13 to change the priority information 153, 163 corresponding to a plurality of functions. For example, the CPU 121 may change the priority information 153, 163 corresponding to a plurality of functions in accordance with an input operation performed by the user 13 through the input device 128.

The CPU 121 selects, out of the plurality of different function information, different function information notified to the user 13 based on the priorities indicated by the priority information 153, 163 (S55). However, the CPU 121 may select the different function information notified to the user 13 without using the priority information 153, 163. The CPU 121 may notify the user 13, for example, only about the different function information that has been specified in advance by the user 13. Or, the CPU 121 may notify the user 13 about the different function information, by randomly selecting five of the different function information from the beginning, regardless of priority.

In the embodiment above, the CPU 121 starts a session with the server apparatus 11 by executing the conference connection process (S31), and then displays the notification window 20C in the display 126 (S43). However, the CPU 121 may display the notification window 20C in the display 126 prior to the execution of the conference connection process. For example, the CPU 121 may notify the organizer about the plurality of different functions by displaying the notification window 20C in the display 126 before the organizer performs an input operation to enter the conference room.

The notification window 20C may be displayed in the display 126 of the communication terminal 12 used by a participant, as well as in the display 126 of the communication terminal 12 used by the organizer. The CPU 121 may display the notification window 20D in the display 126 even in a case other than when the instruction has been detected through the input device 128 (S15: YES). The CPU 121 may display the notification window 20D, for example, immediately after the conference application has started.

The CPU 121 may start the main process as follows. First, the organizer 13A logs in to the Web conference system 1 by use of a Web browser, and then makes the Web browser display a starting window (not shown in a figure) for the conference room. The organizer 13A performs an input operation to give an instruction to start the conference room through the starting window displayed in the Web browser. When detecting the performed input operation to give an instruction to start the conference room, the CPU 121 starts the main process by executing the program stored in the storage 124. By this process, the conference application is executed.

When the program of the conference application is not stored in the storage 124, the CPU 121 may transmit a command to the server apparatus 11 to request acquisition of the program. In response to the reception of the command, the CPU 111 of the server apparatus 11 may transmit the program to the communication terminal 12. The CPU 121 may receive the program transmitted from the server apparatus 11, and may store the received program in the storage 124. The CPU 121 may start the main process by executing the program stored in the storage 124.

In the process in S59 in the embodiment above, the CPU 121 may select a plurality of different function information based on the setting information (showing “disabled”) and priority. Specifically, the CPU 121 may add the number of the different functions corresponding to each priority in the descending order of priority, out of six or more of the different functions selected in the process of S55. When the number of the different functions exceeds “5”, the CPU 121 may preferentially select the different function corresponding to “disabled” as the setting information, out of the different functions corresponding to the priority at that time.

In the processes of S53, S57 and S61 in the embodiment above, the CPU 121 may determine whether the number of the different functions is more than or equal to “5”, instead of determining whether the number is more than “5”.

What is claimed is:

1. A non-transitory computer-readable storage medium storing a program executable on a computer of a communication terminal, the program comprising:
a first acquiring instruction of acquiring, from a storage, first setting information including function identification information, first permission information, and conference identification information that are associated with one another, the function identification information being indicative of a function provided in an application for performing a teleconference that is conducted through a virtual conference room on a network between a plurality of communication terminals, the first permission information being indicative of whether the function is available in a particular virtual conference room, the conference identification information identifying the particular virtual conference room;
a second acquiring instruction of acquiring, from the storage, second setting information including the function identification information, second permission information, and organizer identification information that are associated with one another, the second permission information being indicative of whether the function is available for an organizer of the particular virtual conference room identified by the conference identification information, the organizer identification information identifying the organizer;
a comparing instruction of comparing the first permission information with the second permission information for each of the function indicated by the function identification information, based on the first and second setting information; and
a notifying instruction of, in a particular case, selectively providing notification relating to at least one different function based on a comparison result by the comparing instruction, the at least one different function being indicated by the function identification information of which the first permission information and the second permission information are different from each other.

2. The storage medium according to claim 1, wherein the comparing instruction comprises comparing a number of the at least one different function with a threshold value; and
wherein the notifying instruction comprises, when the number of the at least one different function is larger than the threshold value as a result of comparison by the comparing instruction, providing notification of a different function of a number that is less than or equal to the threshold value, out of the at least one different function.

3. The storage medium according to claim 2, wherein priority information indicative of priority of each of a plurality of functions is associated with the function identification information; and
wherein the notifying instruction comprises, when the number of the at least one different function is larger than the threshold value, notifying a different function of a number less than or equal to the threshold value out of the at least one different function, the different function being selected based on the priority indicated by the priority information.

4. The storage medium according to claim 3, wherein the priority information of a first value is associated with the function identification information indicative of each of a function relating to audio, a function relating to video, and a function relating to document sharing;
wherein the priority information of a second value is associated with the function identification information indicative of a function other than the function relating to audio, the function relating to video, and the function relating to document sharing, the second value being indicative of lower priority than the first value is; and
wherein the notifying instruction comprises notifying the at least one different function of the function relating to audio, the function relating to video, and the function relating to document sharing associated with the priority information of the first value.

5. The storage medium according to claim 2, wherein the notifying instruction comprises, when selecting the different function of the number that is less than or equal to the threshold value, preferentially selecting the different function associated with the second permission information indicating that the different function is unavailable for the organizer of the virtual conference room.

6. The storage medium according to claim 1, wherein the program further comprises a first determining instruction of determining whether an instruction of connecting to the virtual conference room is received; and
wherein the notifying instruction comprises, when it is determined by the first determining instruction that the instruction of connecting to the virtual conference room is received, starting a communication session for conducting a conference and subsequently providing the notification.

7. The storage medium according to claim 1, wherein the program further comprises a second determining instruction of determining whether an instruction of displaying the first setting information is received; and
wherein the notifying instruction comprises, when it is determined by the second determining instruction that the instruction of displaying the first setting information is received, displaying the at least one different function in a different manner from another function.

8. The storage medium according to claim 1, wherein the notifying instruction comprises:
providing the notification when a user of the communication terminal is identical to the organizer identified by the organizer identification information without providing the notification when the user is different from the organizer identified by the organizer identification information.

9. A communication terminal comprising:
a communicator configured to connect to a network;
a hardware processor; and
a memory storing instructions, the instructions, when executed by the processor, causing the processor to perform:
acquiring, from a storage, first setting information including function identification information, first permission information, and conference identification information that are associated with one another, the function identification information being indicative of a function provided in an application for performing a teleconference that is conducted through a virtual conference room on the network between a plurality of communication terminals, the first permission information being indicative of whether the function is available in a particular virtual conference room, the conference identification information identifying the particular virtual conference room;
acquiring, from the storage, second setting information including the function identification information, second permission information, and organizer identification information that are associated with one another, the second permission information being indicative of whether the function is available for an organizer of the particular virtual conference room identified by the conference identification information, the organizer identification information identifying the organizer;
comparing the first permission information with the second permission information for each of the function indicated by the function identification information, based on the first and second setting information, thereby obtaining a comparison result; and
selectively providing, in a particular case, notification relating to at least one different function based on the comparison result, the at least one different function being indicated by the function identification information of which the first permission information and the second permission information are different from each other.

10. A communication method comprising:
acquiring, from a storage, first setting information including function identification information, first permission information, and conference identification information that are associated with one another, the function identification information being indicative of a function provided in an application for performing a teleconference that is conducted through a virtual conference room on a network between a plurality of communication terminals, the first permission information being indicative of whether the function is available in a particular virtual conference room, the conference identification information identifying the particular virtual conference room;
acquiring, from the storage, second setting information including the function identification information, second permission information, and organizer identification information that are associated with one another, the second permission information being indicative of whether the function is available for an organizer of the particular virtual conference room identified by the conference identification information, the organizer identification information identifying the organizer;
comparing the first permission information with the second permission information for each of the function indicated by the function identification information, based on the first and second setting information, thereby obtaining a comparison result; and
selectively providing, in a particular case, notification relating to at least one different function based on the comparison result, the at least one different function being indicated by the function identification information of which the first permission information and the second permission information are different from each other.
